(19) United States
(12) Patent Application Publication
(10) Pub. No.: US 2007/0297666 A1
(43) Pub. Date: Dec. 27, 2007

(54) Information processing apparatus, service providing method, and service providing program product

(76) Inventors: Sachiko Takeuchi, Tokyo (JP); Yutaka Yagiura, Kanagawa (JP)

Correspondence Address: COOPER & DUNHAM, LLP, 1185 AVENUE OF THE AMERICAS, NEW YORK, NY, 10036, US

(21) Appl. No.: 11/810,924

(22) Filed: Jun. 6, 2007

(30) Foreign Application Priority Data
Jun. 22, 2006 (JP) 2006-172509

(51) Int. Cl. G06K 9/62

(52) U.S. Cl. 382/155

(57) ABSTRACT

A disclosed information processing apparatus is connected to an external processing apparatus via a predetermined communication network, and causes the external processing apparatus to perform at least part of a process of a predetermined service on behalf of the information processing apparatus. Information is held for authenticating the external processing apparatus being requested to perform at least part of the process. A request is sent to the external processing apparatus to perform at least part of the process. The external processing apparatus is caused to perform at least part of the process in such a manner to control a function of the information processing apparatus from the outside, in the event of determining, based on the held information, that a request received from the external processing apparatus is authenticated as corresponding to the sent request.

### BACKGROUND OF THE INVENTION

1. Field of the Invention

The present invention relates generally to information processing apparatuses, service providing methods, and service providing program products, and more particularly to an information processing apparatus connected to an external processing apparatus via a predetermined network, a service providing method executed by the information processing apparatus, and a service providing program product.

2. Description of the Related Art

Patent Document 1 discloses an image forming apparatus as an example of an information processing apparatus accommodating functions of various devices such as a printer, a copier, a facsimile machine, and a scanner in a single housing. The image forming apparatus includes a display unit, a printing unit, and an imaging unit in a single housing. Furthermore, the image forming apparatus includes four types of software (applications) corresponding to the printer, the copier, the facsimile, and the scanner, and switches among these four types of software in order to operate as the printer, the copier, the facsimile or the scanner.

Patent Document 1: Japanese Laid-Open Patent Application No. 2002-84383

Conventionally, in developing an application for operating in an image forming apparatus, it is not only necessary to construct the logic of the application itself but also to comply with an I/F for unique device control, an I/F for a unique user interface (UI), and a programming form specific to the image forming apparatus (for example, power source control or registration to SCS described below).

Furthermore, in order to customize an application, it is necessary to be familiar with the I/F for unique device control, the I/F for the unique UI, and the programming form specific to the image forming apparatus. Accordingly, customizing an application is a difficult task.

### SUMMARY OF THE INVENTION

The present invention provides an information processing apparatus, a service providing method, and a service providing program product in which one or more of the above-described disadvantages are eliminated.

A preferred embodiment of the present invention provides an information processing apparatus, a service providing method, and a service providing program product with which software can be easily developed and customized.

An embodiment of the present invention provides an information processing apparatus connected to an external processing apparatus via a predetermined communication network, the information processing apparatus being configured to cause the external processing apparatus to perform at least part of a process of a predetermined service on behalf of the information processing apparatus, the information processing apparatus including a holding unit configured to hold information used for authenticating the external processing apparatus being requested to perform at least part of the process; a requesting unit configured to send a request to the external processing apparatus to perform at least part of the process; a function configured to be controlled according to the process; and a service providing unit configured to cause the external processing apparatus to perform at least part of the process in such a manner to control the function from the outside, in the event of determining, based on the information held by the holding unit, that a request received from the external processing apparatus is authenticated as corresponding to the request sent by the requesting unit.

An embodiment of the present invention provides a service providing method performed by an information processing apparatus connected to an external processing apparatus via a predetermined communication network, the information processing apparatus being configured to cause the external processing apparatus to perform at least part of a process of a predetermined service on behalf of the information processing apparatus, the service providing method including the steps of (a) holding information used for authenticating the external processing apparatus being requested to perform at least part of the process; (b) sending a request to the external processing apparatus to perform at least part of the process; and (c) causing the external processing apparatus to perform at least part of the process in such a manner to control a function of the information processing apparatus from the outside, in the event of determining, based on the information held at step (a), that a request received from the external processing apparatus is authenticated as corresponding to the request sent at step (b).

An embodiment of the present invention provides a service providing program product including instructions for causing a computer of an information processing apparatus connected to an external processing apparatus via a predetermined communication network to execute a procedure, the information processing apparatus being configured to cause the external processing apparatus to perform at least part of a process of a predetermined service on behalf of the information processing apparatus, the procedure including the steps of (a) holding information used for authenticating the external processing apparatus being requested to perform at least part of the process; (b) sending a request to the external processing apparatus to perform at least part of the process; and (c) causing the external processing apparatus to perform at least part of the process in such a manner to control a function of the information processing apparatus from the outside, in the event of determining, based on the information held at step (a), that a request received from the external processing apparatus is authenticated as corresponding to the request sent at step (b).

According to one embodiment of the present invention, an information processing apparatus, a service providing method, and a service providing program product are provided, with which software can be easily developed and customized.

### BRIEF DESCRIPTION OF THE DRAWINGS

Other objects, features and advantages of the present invention will become more apparent from the following detailed description when read in conjunction with the accompanying drawings, in which:

FIG. 1 is a conceptual diagram of an example of a Web service utilization system according to an embodiment of the present invention;

FIG. 2 is a block diagram of an information processing apparatus according to an embodiment of present invention;

FIG. 3 is a hardware block diagram of the information processing apparatus according to an embodiment of the present invention;

FIG. 4 is a diagram of a system configuration of the Web service utilization system according to an embodiment of the present invention;

FIG. 5 is a class diagram illustrating the Web service utilization system according to an embodiment of the present invention;

FIG. 6 illustrates a process flow of modules realized by the classes shown in FIG. 5:

FIG. 7 is a table of examples of authentication methods that can be employed in the Web service utilization system according to an embodiment of the present invention;

FIG. 8 illustrates an example of the structure of a key;

FIG. 9 is a sequence diagram of an authentication method using a key generated by an authentication server;

FIG. 10 is a sequence diagram of an authentication method using a key generated by an image forming apparatus;

FIG. 11 is a sequence diagram of an authentication method using a key generated by a server device;

FIG. 12 is a sequence diagram of an authentication method using identification information; and

FIG. 13 is a sequence diagram of an authentication method using signatures.

### DETAILED DESCRIPTION OF THE PREFERRED EMBODIMENTS

A description is given, with reference to the accompanying drawings, of an embodiment of the present invention.

In the present embodiment, a Web service is taken as an example of a service for controlling a function via a network; however, the present invention is not limited to a Web service.

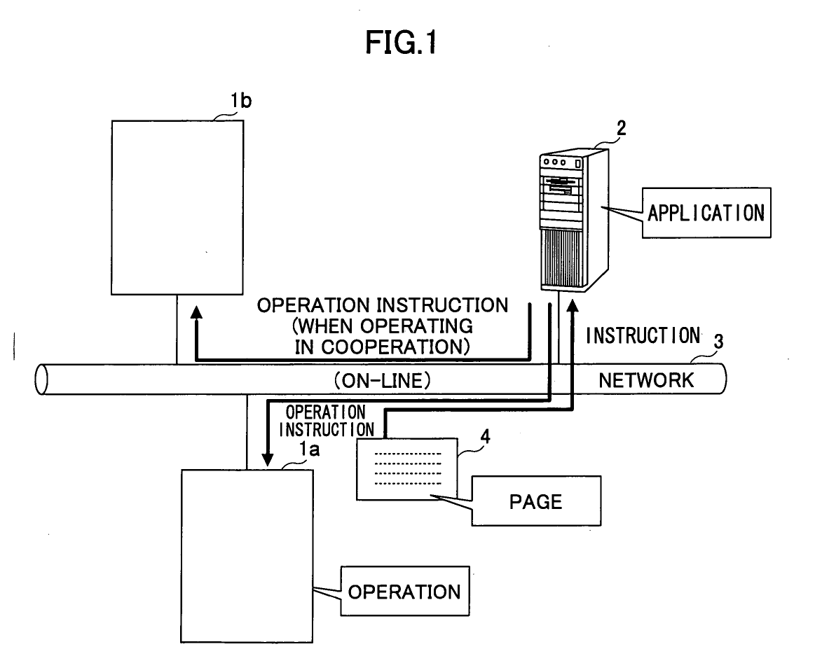

FIG. 1 is a conceptual diagram of an example of a Web service utilization system according to an embodiment of the present invention. The Web service utilization system includes one or more information processing apparatuses 1a, 1b and a server device 2, which are connected via a network 3 such as a LAN or the Internet.

The server device 2 includes an application. The information processing apparatuses 1a, 1b have one or more functions, and provide Web services for controlling the functions from the application of the server device 2 via the network 3. Furthermore, the information processing apparatus 1a includes an operations panel that can display a Web browser.

In the Web service utilization system, an application is constructed in the server device 2 by using a Web service provided by the information processing apparatuses 1a, 1b. The UI of the application is provided by the Web server of the server device 2. The information processing apparatus 1a displays a UI 4 of the application on its operations panel with a Web browser acting as a Web client. The user can operate the application constructed in the server device 2 from the UI 4 of the application displayed on the operations panel.

When a user inputs an instruction of an operation from the UI 4 of the application, the instruction is sent from the Web browser of the information processing apparatus 1a to the Web server of the server device 2. In response to the instruction, the application of the server device 2 sends an operation instruction from its Web service client to the Web service server of the information processing apparatus 1a. In a case where the information processing apparatus 1a and the information processing apparatus 1b are operating in cooperation with each other, an operation instruction is sent from the Web service client of the server device 2 to the Web service server of the information processing apparatus 1b. Communications between the information processing apparatuses 1a, 1b and the server device 2 can be performed by using the SSL protocol in consideration of security.

Furthermore, in performing communications between the information processing apparatuses 1a, 1b and the server device 2, a mechanism is provided for preventing the following problem. An application other than that of the server device 2 accessed by the Web browser of the information processing apparatus 1a may fraudulently use the Web service of the information processing apparatus 1a or the information processing apparatus 1b by masquerading as the application of the server device 2. The mechanism prevents such a fraudulent act.

Specifically, in the Web service utilization system according to an embodiment of the present invention, an instruction from the Web browser of the information processing apparatus 1a to the Web server of the server device 2 and an operation instruction from the Web service client of the server device 2 to the Web service server of the information processing apparatus 1a or the information processing apparatus 1b are associated with each other. Thus, it is easy to determine whether the application that has sent the operation instruction is a proper (authentic) application. Details of the mechanism for preventing masquerading are described further below.

As described above, in the Web service utilization system according shown in FIG. 1, the I/F for unique device control, the I/F for the unique UI, and the programming form specific to the image forming apparatus are covered by the Web service provided by the information processing apparatuses 1a, 1b. Therefore, it is possible to develop/customize an application for controlling the functions of the information processing apparatuses 1a, 1b with a technique as simple as constructing a Web application.

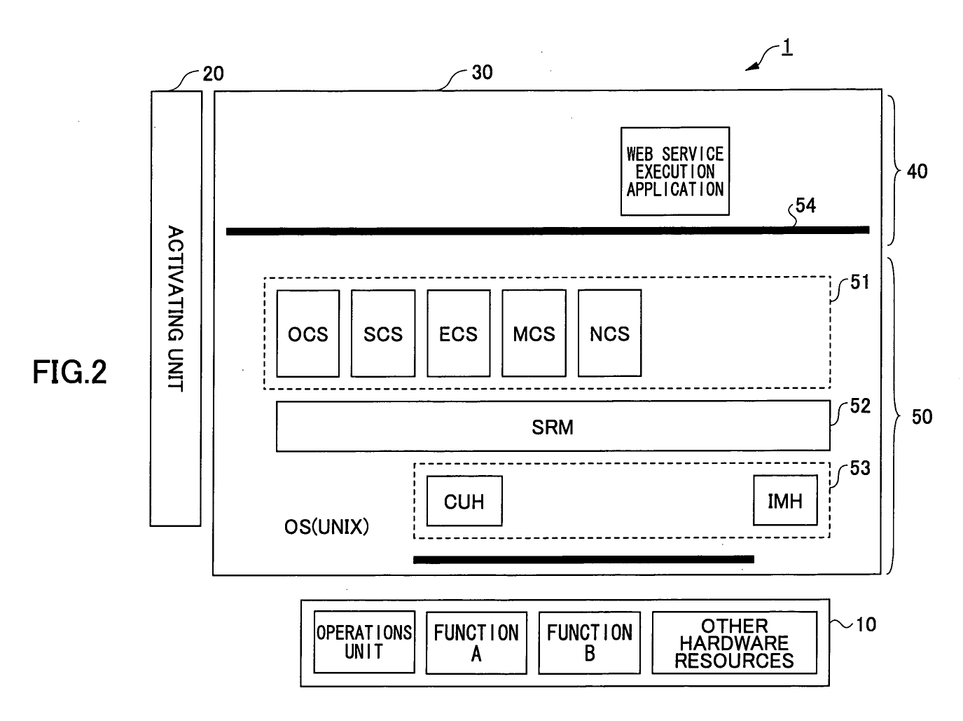

Next, examples of the information processing apparatuses 1a, 1b are described. A reference numeral “1” is used when it does not matter which of the information processing apparatuses 1a, 1b is being referred to. FIG. 2 is a block diagram of the information processing apparatus 1 according to an embodiment of present invention. The information processing apparatus 1 includes hardware resources 10, an activating unit 20, and a software group 30.

The hardware resources 10 include an operations unit and a plurality of devices such as a function A and a function B. If the information processing apparatus 1 were an image forming apparatus, the hardware resources 10 would include a plotter, a scanner, etc.

The software group 30 includes an application 40 executed on an OS such as UNIX (registered trademark) and a platform 50. The platform 50 includes a control service 51, an SRM (system resource manager) 52, and a handler layer 53. The platform 50 is configured to include an API (application program interface) 54. The information processing apparatus 1 can have the required minimum application 40 installed to be used when communications with the server device 2 are off-line.

The control service 51 includes an OCS (operations unit control service), an SCS (system control service), an ECS (engine control service), an MCS (memory control service), and an NCS (network control service). The handler layer 53 includes a CUH (control unit handler) and an IMH (image memory handler).

The OS executes in parallel the software applications in the application 40 and the platform 50 as processes. The OCS processes are performed for controlling the operations unit acting as an information transmission unit for the user to control a main unit. The SCS processes are performed for executing processes to control the system. The ECS processes are performed for controlling an engine unit of the hardware resources 10.

The MCS processes are performed for controlling a memory. The NCS processes are performed for intermediating when transmitting and receiving data. The SRM 52 processes are performed for controlling the system with the SCS and managing the hardware resources 10.

The handler layer 53 includes the CUH (control unit handler) for managing a CU (control unit) to be described below and the IMH (image memory handler) for allocating memory areas to processes and managing the memory areas allocated to the processes. The SRM 52 and the CUH use an engine I/F to send a process request to the hardware resources 10. In the information processing apparatus 1 having the configuration illustrated in FIG. 2, common processes also required by the application 40 can be executed in the platform 50 in an integrated manner.

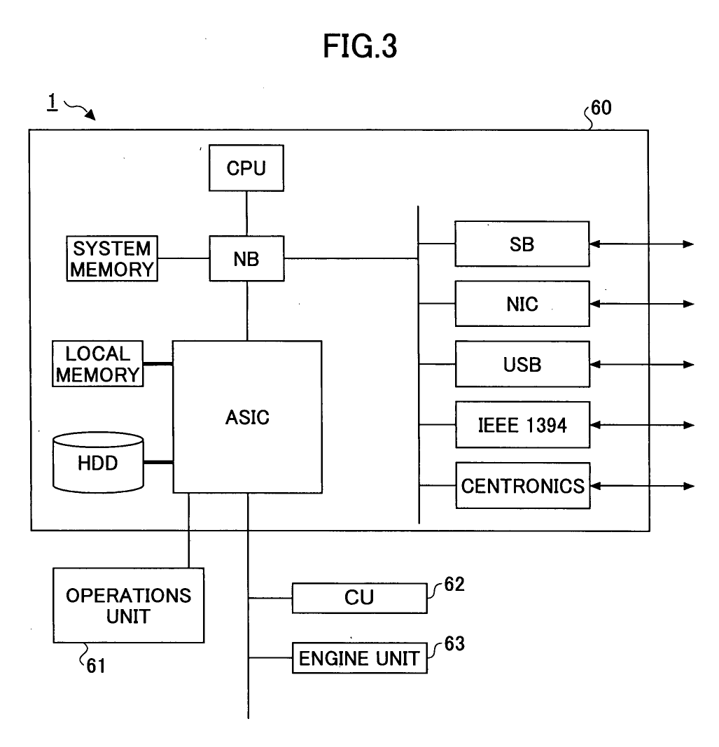

FIG. 3 is a hardware block diagram of the information processing apparatus 1 according to an embodiment of the present invention. The information processing apparatus 1 includes a controller 60, an operations unit 61, a CU 62, and an engine unit 63.

The controller 60 includes a CPU, a system memory, a local memory, a HDD (hard disk drive), an NB (north bridge), an ASIC, an SB (south bridge), an NIC (network interface card), a USB I/F, an IEEE 1394 I/F, and a Centronics I/F.

The CPU controls all units of the information processing apparatus 1. For example, the CPU activates and executes a process on the OS. The NB is a bridge. The SB is a bridge for connecting the PCI bus, the ROM, and peripheral devices. The system memory is used as a processing memory of the information processing apparatus 1. The local memory is used as a processing buffer.

The ASIC is an IC to be used for processes with hardware elements. The HDD is an example of a storage (secondary storage) for storing various data and programs. The NIC is an interface device for connecting the information processing apparatus 1 to the network 3. The USB, the IEEE 1394, and the Centronics are interfaces complying with their respective specifications. The operations unit 61 receives input from a user and displays a page for the user. The CU 62 and the engine unit 63 control the hardware resources 10 of the information processing apparatus 1.

If the information processing apparatus 1 were an image forming apparatus, the block diagram of FIG. 2 and the hardware block diagram of FIG. 3 would appear to be as described in, e.g., Japanese Laid-Open Patent Application No. 2002-84383. Accordingly, details of functions and operations of the blocks in the information processing apparatus 1 shown in FIG. 2 and details of functions and operations of the blocks in the information processing apparatus 1 shown in FIG. 3 can be easily understood by referring to the contents described in, e.g., Japanese Laid-Open Patent Application No. 2002-84383.

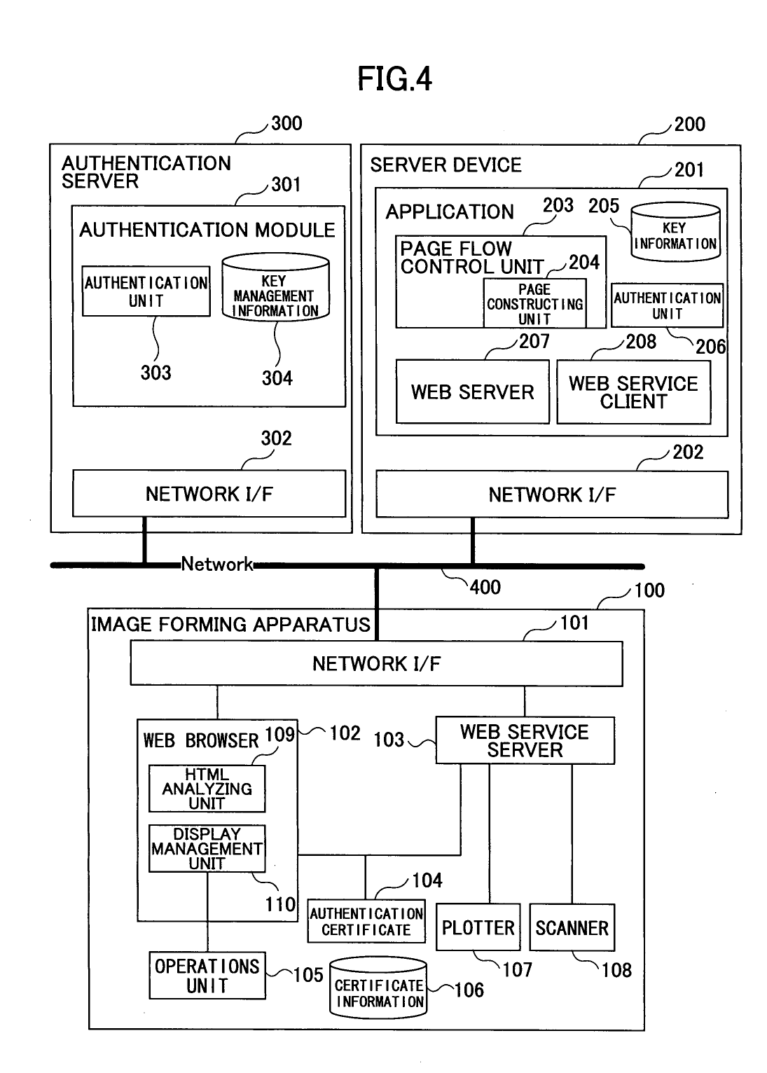

Next, a description is given of details of the Web service utilization system according to an embodiment of the present invention. In this description, an image forming apparatus such as a copier is taken as an example of the information processing apparatus 1 included in the Web service utilization system. FIG. 4 is a diagram of a system configuration of the Web service utilization system according to an embodiment of the present invention. The Web service utilization system shown in FIG. 4 includes an image forming apparatus 100, a server device 200, and an authentication server 300, which are interconnected via a network 400.

The image forming apparatus 100 shown in FIG. 4 includes a network I/F 101, a Web browser 102, a Web service server 103, an authentication certificate 104, an operations unit 105, certificate information 106, a plotter 107, and a scanner 108. The Web browser 102 includes an HTML analyzing unit 109 and a display management unit 110.

The server device 200 includes an application 201 and a network I/F 202. The application 201 includes a page flow control unit 203, a page constructing unit 204, key information 205, an authentication unit 206, a Web server 207, and a Web service client 208.

The authentication server 300 includes an authentication module 301 and a network I/F 302. The authentication module 301 includes an authentication unit 303 and key management information 304.

In the configuration shown in FIG. 4, the authentication server 300 is necessary for generating a key in an embodiment to be described below; however, the authentication server 300 is not an essential component. The authentication unit 206 and the key information 205 of the server device 200 are necessary for generating a key in an embodiment to be described below. However, if the key is to be generated by the image forming apparatus 100, an authentication unit and key information need to be provided in the image forming apparatus 100.

The server device 200 includes the application 201. The image forming apparatus 100 includes one or more functions such as the plotter 107 or the scanner 108. The image forming apparatus 100 provides a Web service with the Web service server 103. With the Web service, a user can control a function of the image forming apparatus 100 from the application 201 of the server device 200 via the network 400. Furthermore, the image forming apparatus 100 includes the operations unit 105 that can display the Web browser 102.

In the Web service utilization system shown in FIG. 4, the application 201 is constructed in the server device 200 by using a Web service provided by the image forming apparatus 100. The UI of the application 201 is provided by the Web server 207 of the server device 200. The image forming apparatus 100 displays a UI of the application 201 on the operations unit 105 with the Web browser 102 acting as a Web client. The user can operate the application 201 constructed in the server device 200 from the UI of the application 201 displayed on the operations panel 105.

When a user inputs an instruction of an operation from the UI of the application 201, the instruction is sent from the Web browser 102 of the image forming apparatus 100 to the Web server 207 of the server device 200. In response to the instruction, the application 201 of the server device 200 sends an operation instruction from the Web service client 208 to the Web service server 103 of the image forming apparatus 100. In a case where the image forming apparatus 100 is operating in cooperation with another image forming apparatus, an operation instruction is sent from the Web service client 208 of the server device 200 to the Web service server of the other image forming apparatus.

In communications between the image forming apparatus 100 and the server device 200, a mechanism is provided for preventing the following problem. An application other than the application 201 of the server device 200 accessed by the Web browser 102 of the information processing apparatus 100 may fraudulently use the Web service of the information processing apparatus 100 by masquerading as the application 201 of the server device 200. The mechanism prevents such a fraudulent act.

Specifically, in the Web service utilization system according to an embodiment of the present invention, an instruction from the Web browser 102 of the image forming apparatus 100 to the Web server 207 of the server device 200 and an operation instruction from the Web service client 208 of the server device 200 to the Web service server 103 of the image forming apparatus 100 are associated with each other in such a manner that the association can be authenticated by cross-checking identification information. Thus, it is easy to determine whether the application 201 that sent the operation instruction is a proper (authentic) application.

The Web service utilization system shown in FIG. 4 constructs an MVC model including Model, View, and Controller. Model corresponds to executing logic. View corresponds to display, input, and output. Controller corresponds to controlling Model and View. Specifically, Controller sends a request to Model to execute the necessary logic in response to input from View, and sends a request to View to display the results.

For example, View in the Web service utilization system shown in FIG. 4 constructs a UI in the server device 200, displays the UI on the Web browser 102 of the image forming apparatus 100, and inputs/outputs specification values. For example, View displays information, changes displayed information, instructs change of information, and instructs execution of a process.

Model is a Web service that controls functions such as the plotter 107 and the scanner 108. For example, Model activates the scanner 108 and turns an image into electronic data. Controller uses an appropriate Web service from the server device 200 in response to a request from the Web browser 102.

For example, when an operation instruction for a copying process is received, Controller executes a scanning operation with the scanner 108 and executes a printing operation with the plotter 107, in accordance with contents of the process. That is, the Controller is equipped with the logic of an image forming application.

In response to an instruction from View displayed on the operations unit 105 of the image forming apparatus 100, Controller of the server device 200 executes an appropriate Model of the image forming apparatus 100. Accordingly, the user of the image forming apparatus 100 can use the image forming application in the server device 200 as if he/she is using an application in the image forming apparatus 100.

As described above, in the Web service utilization system according to an embodiment of the present invention, UI construction is covered by a UI for the Web browser, device control is performed by the Web service client, an execution environment is provided by the server device 200, and the programming form is complied with by the Web service server 103. Accordingly, it is easy to develop/customize an application.

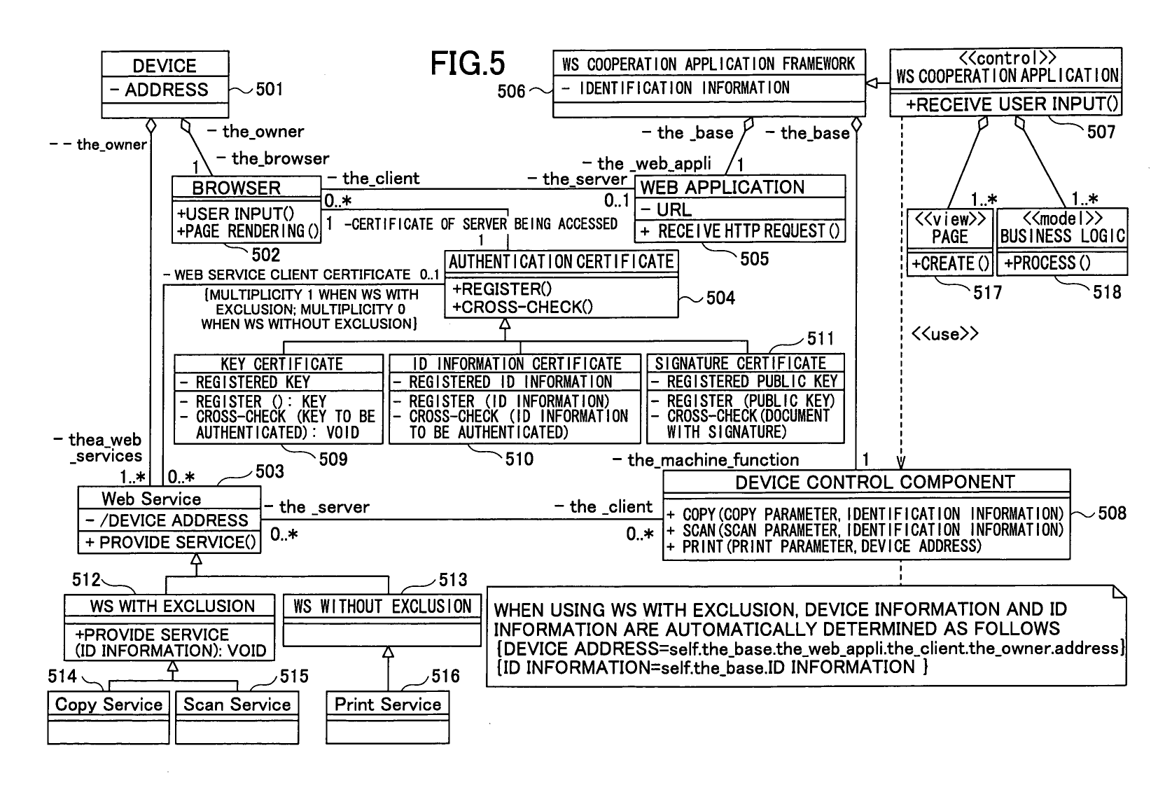

The Web service utilization system according to an embodiment of the present invention can be illustrated by a class diagram shown in FIG. 5. FIG. 5 is a class diagram illustrating the Web service utilization system according to an embodiment of the present invention. In the class diagram shown in FIG. 5, the Web service utilization system is represented by relationships between classes including a device class 501, a browser class 502, a Web service class 503, an authentication certificate class 504, a Web application class 505, a WS cooperation application framework class 506, a WS cooperation application class 507, a device control component class 508, a key certificate class 509, an ID information certificate class 510, a signature certificate class 511, a WS with exclusion class 512, a WS without exclusion class 513, a copy Service class 514, a scan service class 515, a print service class 516, a page class 517, and a business logic class 518.

For example, the device class 501 corresponds to the image forming apparatus 100. The device class 501 includes the browser class 502 and the Web service class 503 as components. The browser class 502 corresponds to the Web browser 102. The Web service class 503 corresponds to the Web service server 103.

For the Web service class 503, the WS with exclusion class 512 and the WS without exclusion class 513 are further defined. For the WS with exclusion class 512, the copy service class 514 and the scan service class 515 are further defined. For the WS without exclusion class 513, the print service class 516 is further defined.

The browser class 502 is associated with the authentication certificate class 504 in a one-on-one manner. The authentication certificate class 504 corresponds to the authentication certificate 104. For the authentication certificate class 504, the key certificate class 509, the ID information certificate class 510, and the signature certificate class 511 are further defined. When the WS with exclusion class 512 is defined, the authentication certificate class 504 is associated with only one class, i.e., the Web service class 503. When the WS without exclusion class 513 is defined, the authentication certificate class 504 is not associated with the Web service class 503.

The browser class 502 is associated with only one class, i.e., the Web application class 505; however, there are cases where the browser class 502 is not associated with the Web application class 505. The Web application class 505 corresponds to the Web server 207. The WS cooperation application framework class 506 includes the Web application class 505 as a component. The WS cooperation application framework class 506 is associated with only one class, i.e., the Web application class 505.

For the WS cooperation application framework class 506, the WS cooperation application class 507 is further defined. The WS cooperation application class 507 corresponds to the application 201. The WS cooperation application class 507 includes the page class 517 and the business logic class 518 as components. The page class 517 and the business logic class 518 correspond to the page flow control unit 203 and the page constructing unit 204, respectively.

Furthermore, the WS cooperation application framework class 506 includes the device control component class 508 as a component. The device control component class 508 corresponds to the Web service client 208. The device control component class 508 is associated with the Web service class 503; however, there are cases where the device control component class 508 is not associated with the Web service class 503.

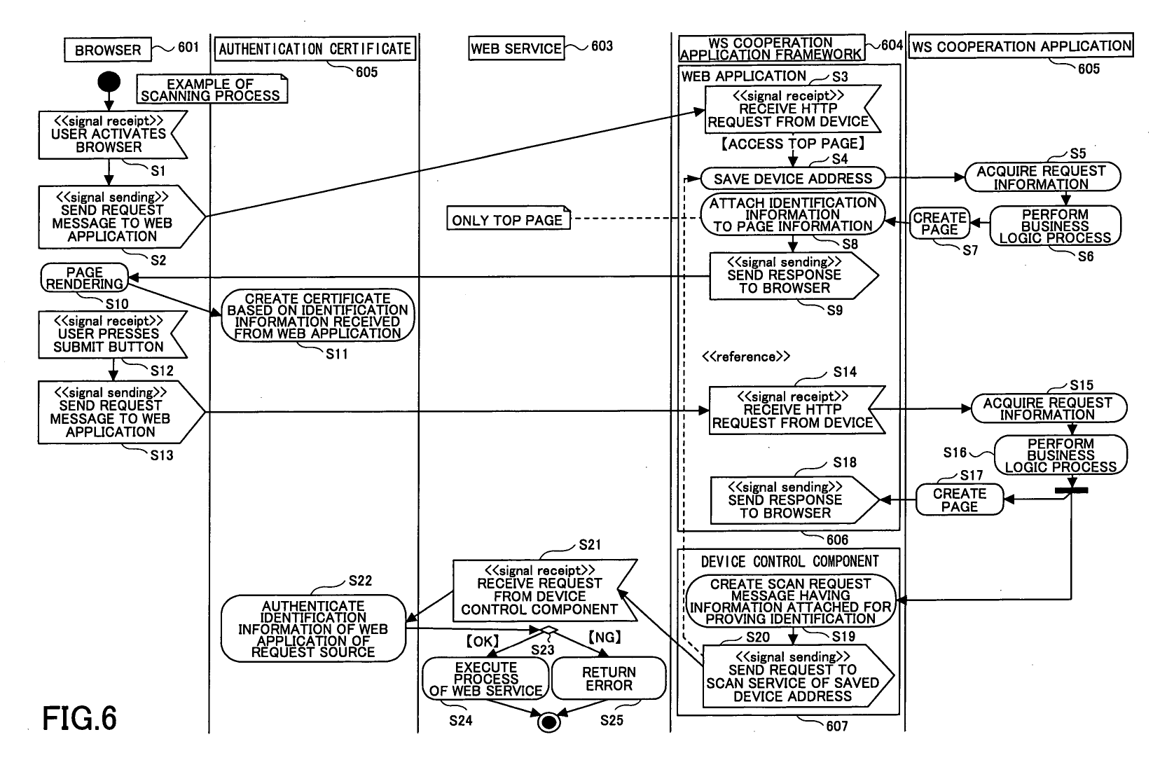

FIG. 6 illustrates a process flow of modules realized by the classes shown in FIG. 5. A scanning process is taken as an example of the process flow shown in FIG. 6. In step S1, the user activates a browser module 601 realized by the browser class 502. In step S2, the browser module 601 sends an http request message for accessing the top page to a Web application module 606 realized by the Web application class 505.

In step S3, the Web application module 606 receives the http request message for accessing the top page from the browser module 601. In step S4, the Web application module 606 saves the device address of the device that sent the http request message.

In step S5, a WS cooperation application module 605 realized by the WS cooperation application class 507 acquires request information (access to the top page) associated with the http request message from the Web application module 606.

In step S6, the WS cooperation application module 605 performs a business logic process according to the request information. In step S7, the WS cooperation application module 605 creates a page according to the business logic process.

In step S8, the Web application module 606 attaches identification information for proving the identification of the device to which it belongs, to page information of the top page. In step S9, the Web application module 606 sends a response to the http request message to the browser module 601.

In step S10, the browser module 601 performs page rendering according to the received response. In step S11, an authentication certificate module 602 realized by the authentication certificate class 504 creates a certificate based on the identification information received from the Web application module 606.

In step S12, the user presses a Submit button of the browser module 601. In step S13, the browser module 601 sends the http request message to the Web application module 606. In step S14, the Web application module 606 receives the http request message from the browser module 601.

In step S15, the WS cooperation application module 605 acquires request information from the Web application module 606. In step S16, the WS cooperation application module 605 performs the business logic process according to the request information. In step S17, the WS cooperation application module 605 creates a page according to the business logic process.

In step S18, the Web application module 606 sends the created page to the browser module 601 as a response to the http request message. The browser module 601 performs page rendering according to the received response.

In step S19, which is performed after step S16, a device control component module 607 realized by the device control component class 508 creates a scan request message that has attached identification information for proving the identification of the device to which it belongs. In step S20, the device control component module 607 identifies the device with the device address saved in step S4, and sends the scan request message that has attached identification information to a Web service module 603 realized by the Web service class 503 of the identified device.

In step S21, the Web service module 603 receives the scan request message that has attached identification information from the device control component module 607. In step S22, the authentication certificate module 602 cross-checks the identification information attached to the scan request message and the identification information of the certificate.

In step S23, if the identification information items are the same, in step S24, the Web service module 603 executes a scan process as the process of the Web service module 603. If the identification information items are not the same in step S23, in step S25, the Web service module 603 returns, for example, an error to the device control component module 607.

As described above, in the Web service utilization system according to an embodiment of the present invention, a request from the browser module 601 to the Web application module 606 and a request from the device control component module 607 to the Web service module 603 are associated with each other in such a manner that the association can be authenticated by cross-checking the identification information. Thus, it is easy to determine whether the device control component module 607 that made the request is the proper (authentic) application.

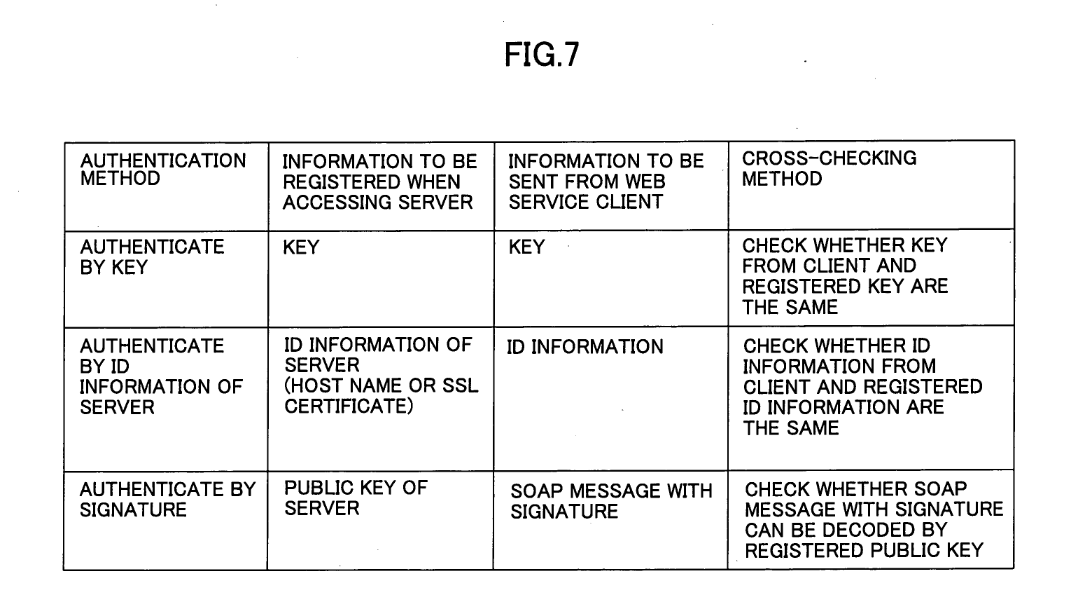

The authentication can be performed by methods other than the authentication method of using identification information, such as an authentication method of using keys or an authentication method of using signatures. FIG. 7 is a table of examples of authentication methods that can be employed in the Web service utilization system according to an embodiment of the present invention.

In the authentication method using keys, a key is used as information to be registered when accessing the Web server 207 and a key is used as information to be sent from the Web service client 208 to the Web service server 103. The key sent from the Web service client 208 to the Web service server 103 and the key registered when accessing the Web server 207 are cross-checked to determine whether they are the same.

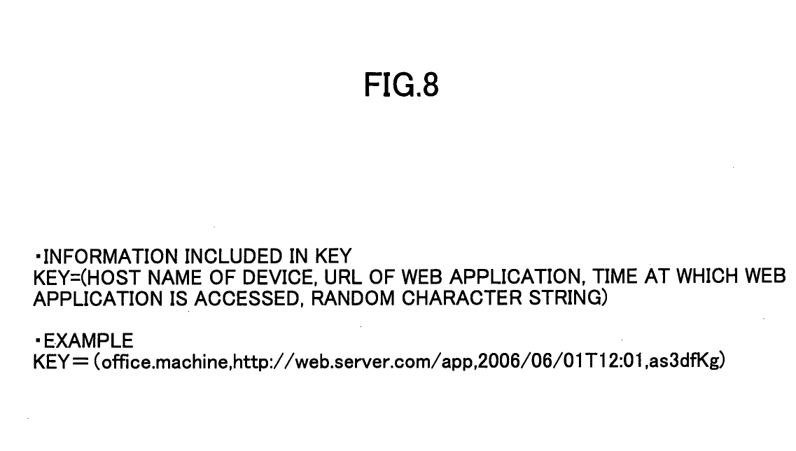

FIG. 8 illustrates an example of the structure of the key. The key can include information such as a host name of a device, the URL of the application (Web application), the time at which the application is accessed, and a random character string.

In an authentication method using identification information, identification information (e.g., a host name or an SSL certificate) of the Web server 207 can be used as information to be registered when accessing the Web server 207 and identification information can be used as information to be sent from the Web service client 208 to the Web service server 103. The identification information sent from the Web service client 208 to the Web service server 103 and the identification information registered when accessing the Web server 207 are cross-checked to determine whether they are the same.

In an authentication method using signatures, a public key of the Web server 207 can be used as information to be registered when accessing the Web server 207 and a SOAP message with a signature can be used as information to be sent from the Web service client 208 to the Web service server 103. A cross-check is performed to determine whether the SOAP message with the signature can be decoded by the public key of the Web server 207.

Variations of processes of the Web service utilization system are described in the following examples. In the following descriptions, a scanning process is taken as an example. The present invention is not limited to the specifically disclosed embodiments and examples, and variations and modifications may be made without departing from the scope of the present invention.

### FIRST EXAMPLE

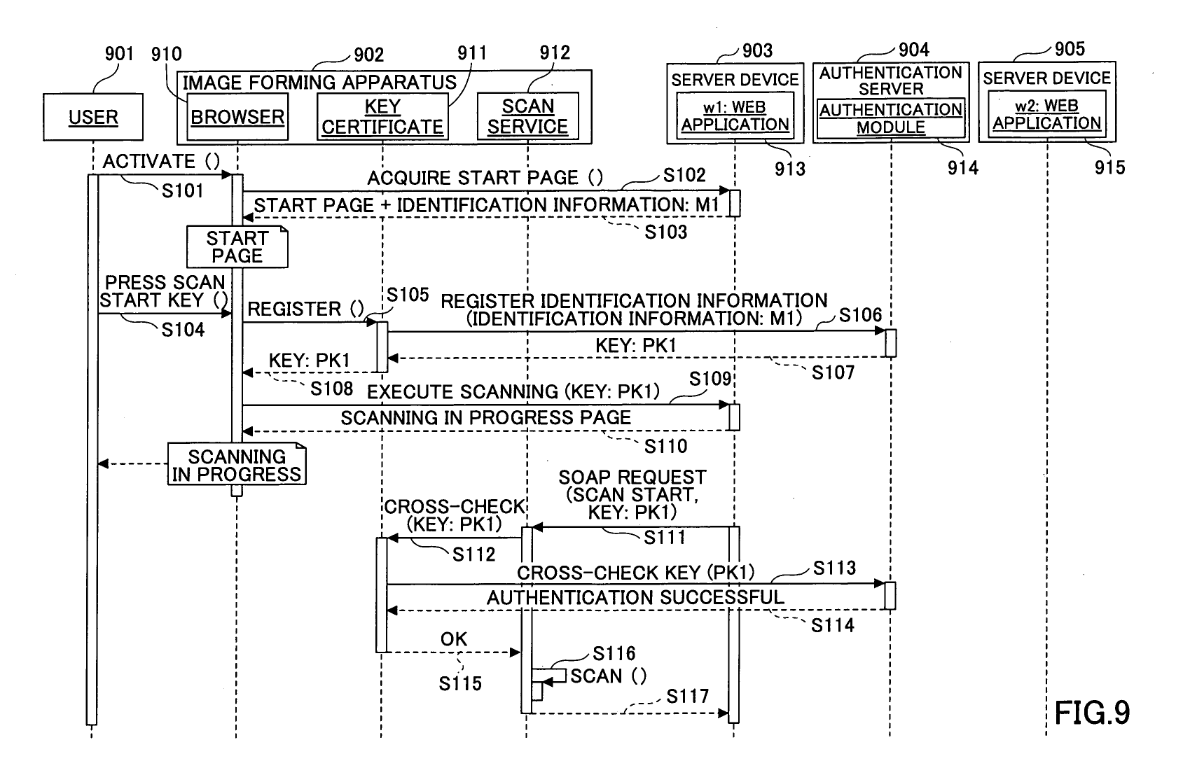

FIG. 9 is a sequence diagram of an authentication method using a key generated by an authentication server. In step S101, a user 901 operates the operations unit 105 of an image forming apparatus 902 to cause the image forming apparatus 902 to activate a browser module 910.

In step S102, the browser module 910 sends a request to acquire a start page to a Web application module 913 of a server device 903. In step S103, in response to the request from the browser module 910, the Web application module 913 sends, to the browser module 910, the start page and identification information M1 of the server device 903 to which it belongs.

The browser module 910 displays the start page on the operations unit 105. In step S104, the user 901 presses a scan start key of the operations unit 105. In response to the user 901 pressing the scan start key, in step S105, the browser module 910 sends a request to register a key in a key certificate module 911. The key certificate module 911 is realized by the key certificate class 509.

In step S106, the key certificate module 911 sends a request to register the identification information M1 in an authentication module 914 of an authentication server 904. In step S107, the authentication module 914 generates a key PK1 from the identification information M1, registers the key PK1, and sends the key PK1 to the key certificate module 911. In step S108, in response to the request to register the key, the key certificate module 911 sends the key PK1 to the browser module 910.

In step S109, the browser module 910 sends to the Web application module 913 of the server device 903 a request to execute a scanning operation with the key PK1 attached to the request. In step S110, in response to receiving the request to execute a scanning operation, the Web application module 913 sends a “scanning in progress” page to the browser module 910. The browser module 910 displays the “scanning in progress” page on the operations unit 105 for indicating to the user 901 that scanning is in progress.

In step S111, the Web application module 913 sends a SOAP request including a scan start instruction and the key PK1 to a scan service module 912 of the image forming apparatus 902, which scan service module 912 is realized by the scan service class 515. In step S112, the scan service module 912 sends a request to the key certificate module 911 to cross-check the key PK1 with the registered key.

In step S113, the key certificate module 911 sends a request to the authentication module 914 of the authentication server 904 to cross-check the key PK1 with the registered key. The authentication module 914 cross-checks the key PK1, for which the cross-check request is made, with the key already registered to determine whether they are the same. That is, in the Web service utilization system according to an embodiment of the present invention, it is easy to determine whether the device that gives an instruction to execute the scanning operation in step S109 is the same as the device that receives the scan start instruction in step S111. When it is determined that the keys are the same as the result of the cross-check, in step S114, the authentication module 914 sends a report to the key certificate module 911 that the key PK1 is authenticated as a result of the cross-check.

In step S115, the key certificate module 911 sends a report to the scan service module 912 that the key PK1 is authenticated as a result of the cross-check. In step S116, the scan service module 912 executes the scanning operation. In step S117, the scan service module 912 sends a report to the Web application module 913 in response to the SOAP request received in step S111.

### SECOND EXAMPLE

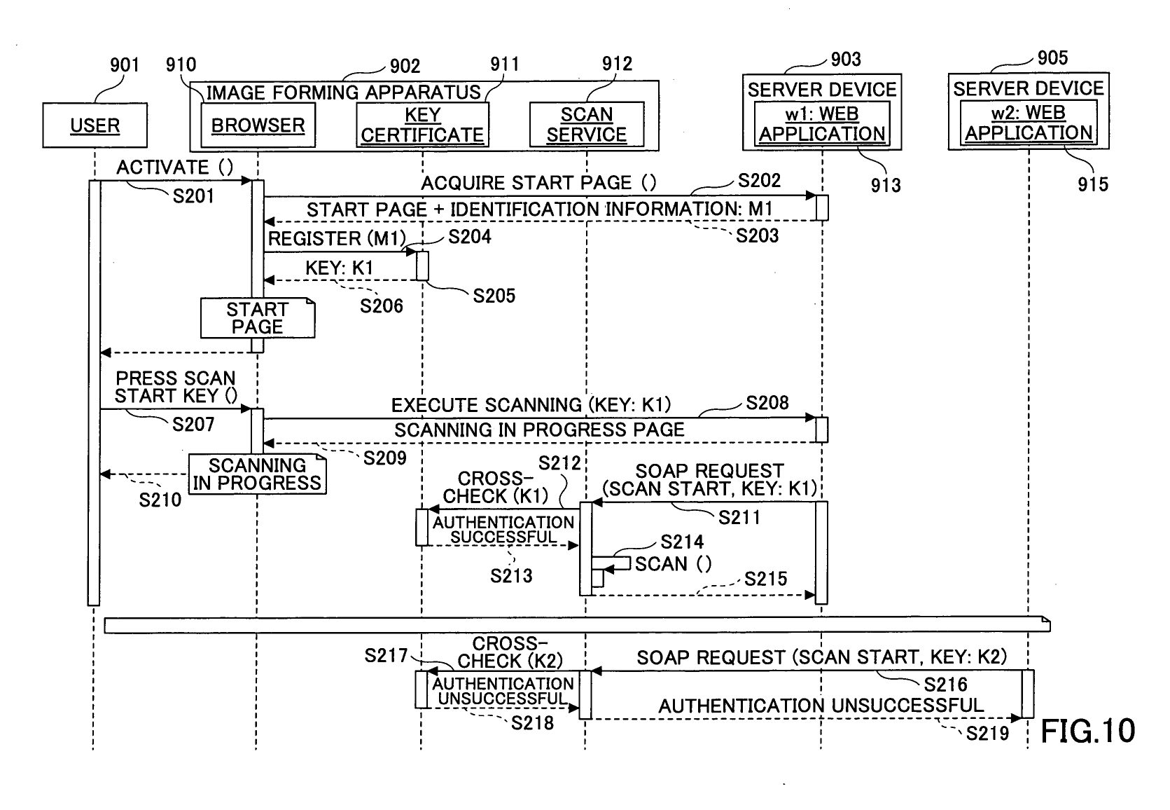

FIG. 10 is a sequence diagram of an authentication method using a key generated by an image forming apparatus. In step S201, a user 901 operates the operations unit 105 of the image forming apparatus 902 to cause the image forming apparatus 902 to activate the browser module 910.

In step S202, the browser module 910 sends a request to acquire a start page to the Web application module 913 of the server device 903. In step S203, in response to the request from the browser module 910, the Web application module 913 sends, to the browser module 910, the start page and identification information M1 of the server device 903 to which it belongs.

In step S204, the browser module 910 sends a request to register a key in the key certificate module 911. In step S205, the key certificate module 911 generates a key K1 from the identification information M1 and registers the key K1. In step S206, in response to the request to register the key, the key certificate module 911 sends the key K1 to the browser module 910.

The browser module 910 displays the start page on the operations unit 105. In step S207, the user 901 presses a scan start key of the operations unit 105. In response to the user 901 pressing the scan start key, in step S208, the browser module 910 sends to the Web application module 913 of the server device 903 a request to execute a scanning operation with the key K1 attached to the request. In step S209, in response to receiving the request to execute a scanning operation, the Web application module 913 sends a “scanning in progress” page to the browser module 910. The browser module 910 displays the “scanning in progress” page on the operations unit 105 for indicating to the user 901 that scanning is in progress (step S210).

In step S211, the Web application module 913 sends a SOAP request including a scan start instruction and the key K1 to the scan service module 912 of the image forming apparatus 902. In step S212, the scan service module 912 sends a request to the key certificate module 911 to cross-check the key K1 with the registered key.

In step S213, the key certificate module 911 cross-checks the key K1, for which the cross-check request is made, with the key already registered to determine whether they are the same. That is, in the Web service utilization system according to an embodiment of the present invention, it is easy to determine whether the device that gives an instruction to execute the scanning operation in step S208 is the same as the device that receives the scan start instruction in step S211. When it is determined that the keys are the same as the result of the cross-check, the key certificate module 911 sends a report to the scan service module 912 that the key K1 is authenticated as a result of the cross-check.

In response to receiving the report that the key K1 is authenticated, in step S214, the scan service module 912 executes the scanning operation. When execution of the scanning operation starts, step S215 is performed. In step S215, the scan service module 912 sends a report to the Web application module 913 in response to the SOAP request received in step S211.

The following describes an example in which a SOAP request including a scan start instruction and a key K2 is sent to the scan service module 912 of the image forming apparatus 902 from a Web application module 915 included in a server device 905 other than the server device 903.

In step S216, the Web application module 915 sends the SOAP request including a scan start instruction and the key K2 to the scan service module 912 of the image forming apparatus 902. In step S217, the scan service module 912 sends a request to the key certificate module 911 to cross-check the key K2 with the registered key.

In step S218, as the key K2 for which the cross-check request is made is not the same as the key K1 already registered, the key certificate module 911 sends a report to the scan service module 912 that the key K2 cannot be authenticated (is not authentic) as a result of the cross-check. When the report that the key K2 is not authentic is received, in step S219, the scan service module 912 sends a report that the key K2 is not authentic to the Web application module 915 in response to the SOAP request received in step S216.

### THIRD EXAMPLE

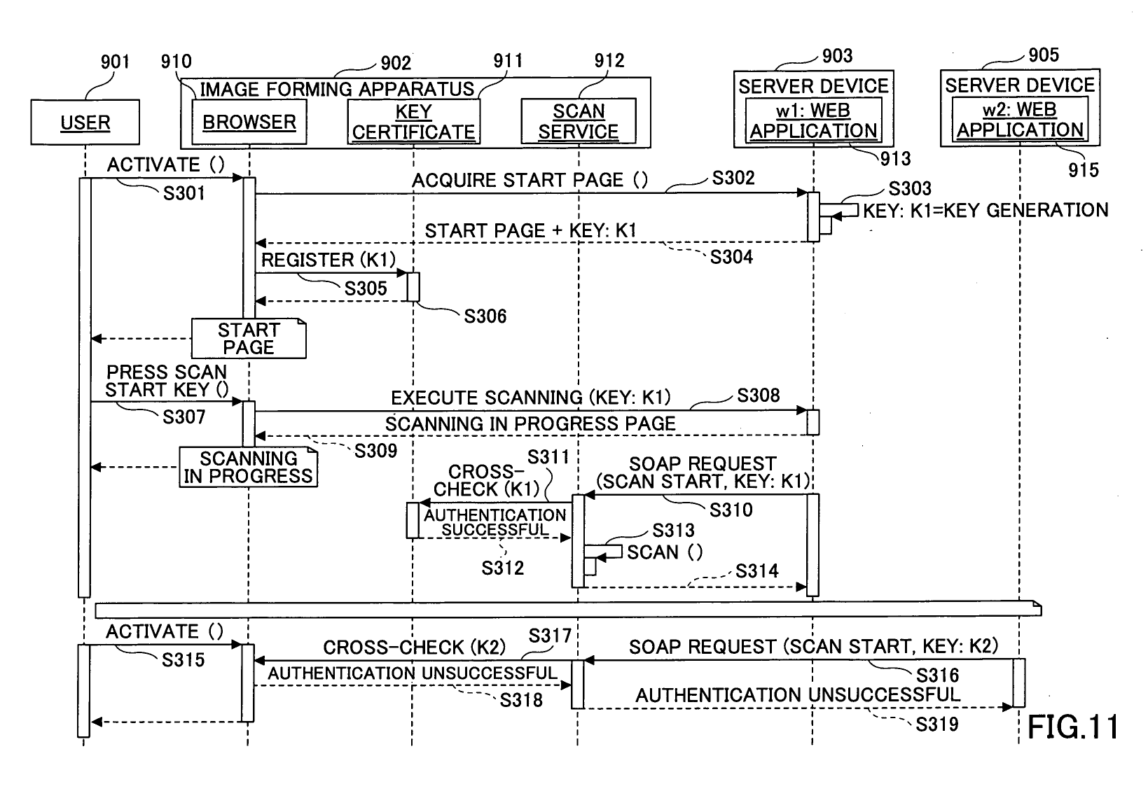

FIG. 11 is a sequence diagram of an authentication method using a key generated by a server device. In step S301, a user 901 operates the operations unit 105 of the image forming apparatus 902 to cause the image forming apparatus 902 to activate the browser module 910.

In step S302, the browser module 910 sends a request to acquire a start page to the Web application module 913 of the server device 903. In step S303, the Web application module 913 generates a key K1 from identification information M1 of the server device 903 to which it belongs. In step S304, in response to the request from the browser module 910, the Web application module 913 sends the start page and the key K1 to the browser module 910.

In step S305, the browser module 910 sends a request to register the key K1 in the key certificate module 911. In step S306, the key certificate module 911 registers the key K1. The key certificate module 911 sends a response to the request to register the key K1 in the browser module 910.

The browser module 910 displays the start page on the operations unit 105. In step S307, the user 901 presses a scan start key of the operations unit 105. In response to the user 901 pressing the scan start key, in step S308, the browser module 910 sends to the Web application module 913 of the server device 903 a request to execute a scanning operation with the key K1 attached to the request. In step S309, in response to receiving the request to execute a scanning operation, the Web application module 913 sends a “scanning in progress” page to the browser module 910. The browser module 910 displays the “scanning in progress” page on the operations unit 105 for indicating to the user 901 that scanning is in progress.

In step S310, the Web application module 913 sends a SOAP request including a scan start instruction and the key K1 to the scan service module 912 of the image forming apparatus 902. In step S311, the scan service module 912 sends a request to the key certificate module 911 to cross-check the key K1 with the registered key.

In step S312, the key certificate module 911 cross-checks the key K1, for which the cross-check request is made, with the key already registered to determine whether they are the same. That is, in the Web service utilization system according to an embodiment of the present invention, it is easy to determine whether the device that gives an instruction to execute the scanning operation in step S308 is the same as the device that receives the scan start instruction in step S310. When it is determined that the keys are the same as the result of the cross-check, the key certificate module 911 sends a report to the scan service module 912 that the key K1 is authenticated as a result of the cross-check.

In response to receiving the report that the key K1 is authenticated, in step S313, the scan service module 912 executes the scanning operation. When execution of the scanning operation starts, step S314 is performed. In step S314, the scan service module 912 sends a report to the Web application module 913 in response to the SOAP request received in step S310.

The following describes an example in which a SOAP request including a scan start instruction and a key K2 is sent to the scan service module 912 of the image forming apparatus 902 from the Web application module 915 included in the server device 905 other than the server device 903.

In step S315, a user 901 operates the operations unit 105 of the image forming apparatus 902 to cause the image forming apparatus 902 to activate the browser module 910. In step S316, the Web application module 915 sends the SOAP request including a scan start instruction and the key K2 to the scan service module 912 of the image forming apparatus 902. In step S317, the scan service module 912 sends a request to the browser module 910 to cross-check the key K2 with the registered key.

In step S318, as the key K2 for which the cross-check request is made is not the same as the key K1 already registered, the browser module 910 sends a report to the scan service module 912 that the key K2 cannot be authenticated (is not authentic) as a result of the cross-check.

When the report that the key K2 is not authentic is received, in step S319, the scan service module 912 sends a report that the key K2 is not authentic to the Web application module 915 in response to the SOAP request received in step S316.

### FOURTH EXAMPLE

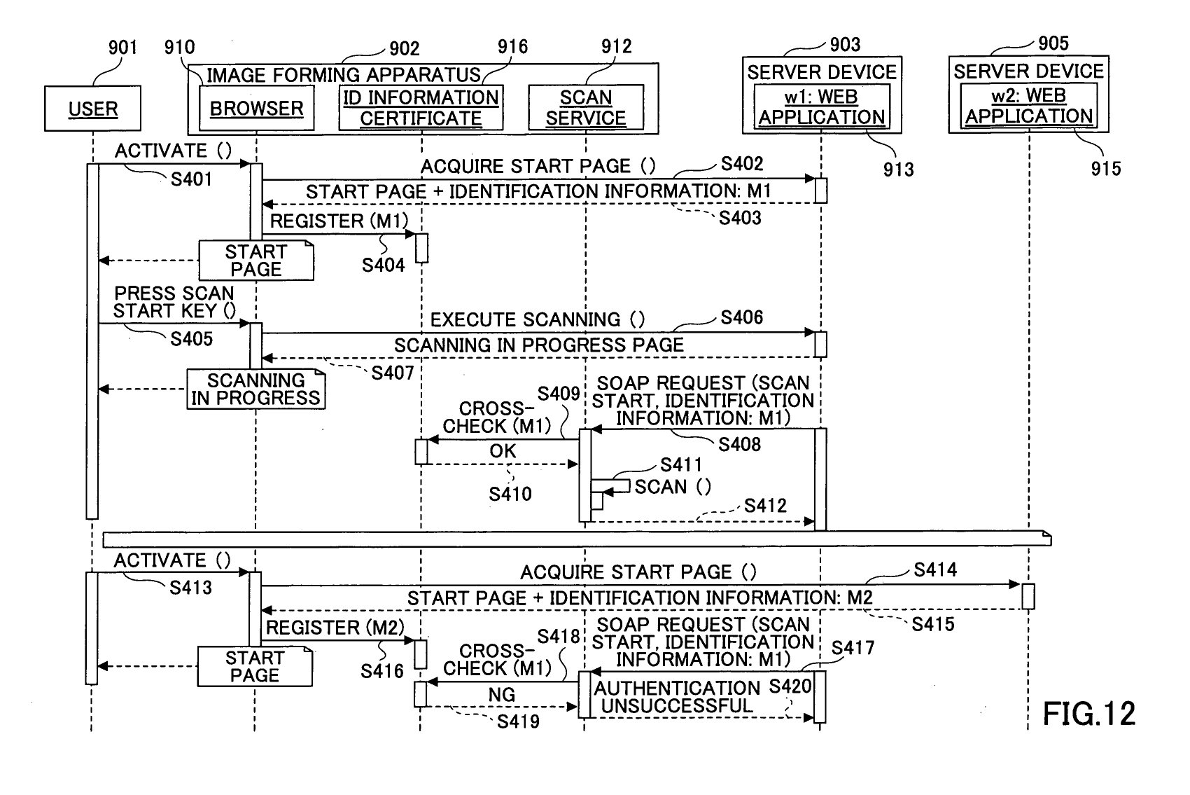

FIG. 12 is a sequence diagram of an authentication method using identification information. In step S401, a user 901 operates the operations unit 105 of the image forming apparatus 902 to cause the image forming apparatus 902 to activate the browser module 910.

In step S402, the browser module 910 sends a request to acquire a start page to the Web application module 913 of the server device 903. In step S403, in response to the request from the browser module 910, the Web application module 913 sends, to the browser module 910, the start page and identification information M1 of the server device 903 to which it belongs. Examples of the identification information M1 include an SSL certificate and an IP address.

In step S404, the browser module 910 sends a request to register the identification information M1 in an ID information certificate class 916, which is realized by the ID information certificate class 510. The ID information certificate class 916 registers the identification information M1.

The browser module 910 displays the start page on the operations unit 105. In step S405, the user 901 presses a scan start key of the operations unit 105. In response to the user 901 pressing the scan start key, in step S406, the browser module 910 sends to the Web application module 913 of the server device 903 a request to execute a scanning operation.

In step S407, the Web application module 913 sends a “scanning in progress” page to the browser module 910. The browser module 910 displays the “scanning in progress” page on the operations unit 105 for indicating to the user 901 that scanning is in progress.

In step S408, the Web application module 913 sends a SOAP request including a scan start instruction and the identification information M1 to the scan service module 912 of the image forming apparatus 902. In step S409, the scan service module 912 sends a request to the ID information certificate class 916 to cross-check the identification information M1 with the registered identification information.

In step S410, the ID information certificate class 916 cross-checks the identification information M1, for which the cross-check request is made, with the identification information already registered to determine whether they are the same. That is, in the Web service utilization system according to an embodiment of the present invention, it is easy to determine whether the device that gives an instruction to execute the scanning operation in step S406 is the same as the device that receives the scan start instruction in step S408. When it is determined that the identification information items are the same as the result of the cross-check, the ID information certificate class 916 sends a report to the scan service module 912 that the identification information M1 is authenticated as a result of the cross-check.

In response to receiving the report that the identification information M1 is authenticated, in step S411, the scan service module 912 executes the scanning operation. When execution of the scanning operation starts, step S412 is performed. In step S412, the scan service module 912 sends a report to the Web application module 913 in response to the SOAP request received in step S408.

The following describes an example in which a SOAP request including a scan start instruction and identification information M2 is sent from the Web application module 915 included in the server device 905 other than the server device 903 to the scan service module 912 of the image forming apparatus 902.

In step S413, a user 901 operates the operations unit 105 of the image forming apparatus 902 to cause the image forming apparatus 902 to activate the browser module 910. In step S414, the browser module 910 sends a request to acquire a start page to the Web application module 915 of the server device 905. In step S415, in response to the request from the browser module 910, the Web application module 915 sends the start page and the identification information M2 of the server device 905 to which it belongs to the browser module 910. In step S416, the browser module 910 sends a request to register the identification information M2 in the ID information certificate class 916. The ID information certificate class 916 registers the identification information M2.

The browser module 910 displays the start page on the operations unit 105. In step S417, the Web application module 913 of the server device 903 sends a SOAP request including a scan start instruction and the identification information M1 to the scan service module 912 of the image forming apparatus 902. In step S418, the scan service module 912 sends a request to the ID information certificate class 916 to cross-check the identification information M1 with the registered identification information.

In step S419, as the identification information M1 for which the cross-check request is made is not the same as the identification information M2 already registered, the ID information certificate class 916 sends a report to the scan service module 912 that the identification information M1 cannot be authenticated (is not authentic) as a result of the cross-check. When the report that the identification information M1 is not authentic is received, in step S420, the scan service module 912 sends a report that the identification information M1 is not authentic to the Web application module 913 in response to the SOAP request received in step S417.

### FIFTH EXAMPLE

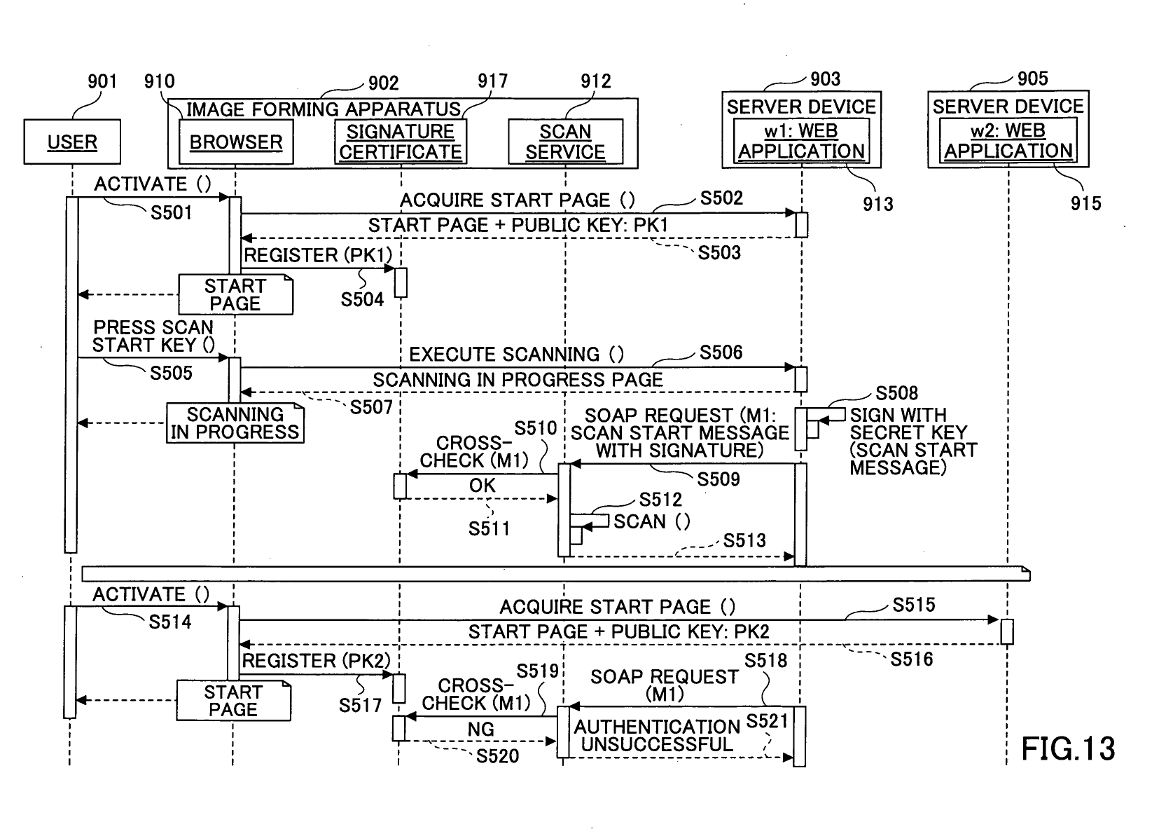

FIG. 13 is a sequence diagram of an authentication method using signatures. In step S501, a user 901 operates the operations unit 105 of the image forming apparatus 902 to cause the image forming apparatus 902 to activate the browser module 910.

In step S502, the browser module 910 sends a request to acquire a start page to the Web application module 913 of the server device 903. In step S503, in response to the request from the browser module 910, the Web application module 913 sends to the browser module 910 the start page and a public key PK1 of the server device 903 to which it belongs.

In step S504, the browser module 910 sends a request to register the public key PK1 in a signature certificate module 917, which is realized by the signature certificate class 511. The signature certificate module 917 registers the public key PK1.

The browser module 910 displays the start page on the operations unit 105. In step S505, the user 901 presses a scan start key of the operations unit 105. In response to the user 901 pressing the scan start key, in step S506, the browser module 910 sends to the Web application module 913 of the server device 903 a request to execute a scanning operation.

In step S507, the Web application module 913 sends a “scanning in progress” page to the browser module 910. The browser module 910 displays the “scanning in progress” page on the operations unit 105 for indicating to the user 901 that scanning is in progress.

In step S508, the Web application module 913 signs a scan start instruction with a secret key PK1. In step S509, the Web application module 913 sends a SOAP request including a scan start message signed with a signature M1 to the scan service module 912 of the image forming apparatus 902.

In step S510, the scan service module 912 sends a request to the signature certificate module 917 to cross-check the signature M1 with the public key PK1. In step S511, the signature certificate module 917 cross-checks the signature M1, for which the cross-check request is made, with the public key PK1 already registered to determine whether the signature M1 can be decoded by the public key PK1.

That is, in the Web service utilization system according to an embodiment of the present invention, it is easy to determine whether the device that gives an instruction to execute the scanning operation in step S506 is the same as the device that receives the scan start instruction in step S509. When it is determined that the signature M1 can be decoded by the public key PK1 as the result of the cross-check, the signature certificate module 917 sends a report to the scan service module 912 that the signature M1 is authenticated as a result of the cross-check.

In response to receiving the report that the signature M1 is authenticated, in step S512, the scan service module 912 executes the scanning operation. When execution of the scanning operation starts, step S513 is performed. In step S513, the scan service module 912 sends a report to the Web application module 913 in response to the SOAP request received in step S509.

The following describes an example in which a SOAP request including a public key PK2 of the Web application module 915 is sent from the Web application module 915 included in the server device 905 other than the server device 903 to the scan service module 912 of the image forming apparatus 902.

In step S514, a user 901 operates the operations unit 105 of the image forming apparatus 902 to cause the image forming apparatus 902 to activate the browser module 910. In step S515, the browser module 910 sends a request to acquire a start page to the Web application module 915 of the server device 905. In step S516, in response to the request from the browser module 910, the Web application module 915 sends, to the browser module 910, the start page and the public key PK2 of the server device 905 to which it belongs. In step S517, the browser module 910 sends a request to register the public key PK2 in the signature certificate module 917. The signature certificate module 917 registers the public key PK2. The browser module 910 displays the start page on the operations unit 105.

In step S518, the Web application module 913 of the server device 903 sends a SOAP request including a scan start message signed with a signature M1 to the scan service module 912 of the image forming apparatus 902.

In step S519, the scan service module 912 sends a request to the signature certificate module 917 to cross-check the signature M1 with the public key PK2. In step S520, as the signature M1 for which the cross-check request is made cannot be decoded by the public key PK2, the signature certificate module 917 sends a report to the scan service module 912 that the signature M1 cannot be authenticated (is not authentic) as a result of the cross-check. In step S521, the scan service module 912 sends a report that the signature M1 is not authentic to the Web application module 913 in response to the SOAP request received in step S518.

According to one embodiment of the present invention, an external processing apparatus can perform at least part of a process pertaining to a service on behalf of an information processing apparatus, and functions of the information processing apparatus (e.g., controlling the application behavior, controlling the page) can be controlled in the event of receiving a request from the external processing apparatus.

Further, according to one embodiment of the present invention, it is possible to develop/customize software for controlling the functions of the information processing apparatus with a technique as simple as constructing a Web application.

Further, according to one embodiment of the present invention, it is possible to prevent masquerading and reinforce security by checking whether the external processing apparatus that requested at least part of a process pertaining to a service can be authenticated.

The components, expressions, and arbitrary combinations of components of the present invention can be effectively applied to a method, an apparatus, a system, a computer program product, a recording medium, a data structure, etc.

The present application is based on Japanese Priority Patent Application No. 2006-172509, filed on Jun. 22, 2006, the entire contents of which are hereby incorporated by reference.

What is claimed is:

1. An information processing apparatus connected to an external processing apparatus via a predetermined communication network, the information processing apparatus-being configured to cause the external processing apparatus to perform at least part of a process of a predetermined service on behalf of the information processing apparatus, the information processing apparatus comprising:
a holding unit configured to hold information used for authenticating the external processing apparatus being requested to perform at least part of the process;
a requesting unit configured to send a request to the external processing apparatus to perform at least part of the process;
a function configured to be controlled according to the process; and
a service providing unit configured to cause the external processing apparatus to perform at least part of the process in such a manner to control the function from the outside, in the event of determining, based on the information held by the holding unit, that a request received from the external processing apparatus is authenticated as corresponding to the request sent by the requesting unit.

2. The information processing apparatus according to claim 1, wherein:
the requesting unit sends the request to perform at least part of the process to the external processing apparatus using the function of the information processing apparatus.

3. The information processing apparatus according to claim 1, wherein:
the requesting unit sends the request to perform at least part of the process to a control unit of the external processing apparatus that controls the function from the outside by using the service providing unit.

4. The information processing apparatus according to claim 1, wherein:
the holding unit holds identification information of the external processing apparatus as the information used for authenticating the external processing apparatus being requested to perform at least part of the process; and
the service providing unit compares identification information included in the request received from the external processing apparatus with the identification information held by the holding unit to determine whether the request received from the external processing apparatus can be authenticated as corresponding to the request sent by the requesting unit.

5. The information processing apparatus according to claim 1, wherein:
the holding unit holds a key generated from identification information of the external processing apparatus as the information used for authenticating the external processing apparatus being requested to perform at least part of the process; and
the service providing unit compares a key included in the request received from the external processing apparatus with the key held by the holding unit to determine whether the request received from the external processing apparatus can be authenticated as corresponding to the request sent by the requesting unit.

6. The information processing apparatus according to claim 5, wherein:
the key held by the holding unit is generated by an authentication server connected to the information processing apparatus via the communication network.

7. The information processing apparatus according to claim 5, wherein:
the key held by the holding unit is generated by the information processing apparatus.

8. The information processing apparatus according to claim 5, wherein:
the key held by the holding unit is generated by the external processing apparatus.

9. The information processing apparatus according to claim 5, wherein:
the key held by the holding unit comprises at least one of a host name of the external processing apparatus, a location of the external processing apparatus in the communication network, a time at which the request is sent from the requesting unit to the external processing apparatus, and a random character string.

10. The information processing apparatus according to claim 1, wherein:
the holding unit holds a public key of the external processing apparatus as the information used for authenticating the external processing apparatus being requested to perform at least part of the process; and
the service providing unit determines whether a message with a signature included in the request received from the external processing apparatus can be decoded by the public key held by the holding unit to determine whether the request received from the external processing apparatus can be authenticated as corresponding to the request sent by the requesting unit.

11. A service providing method performed by an information processing apparatus connected to an external processing apparatus via a predetermined communication network, the information processing apparatus being configured to cause the external processing apparatus to perform at least part of a process of a predetermined service on behalf of the information processing apparatus, the service providing method comprising the steps of:
(a) holding information used for authenticating the external processing apparatus being requested to perform at least part of the process;
(b) sending a request to the external processing apparatus to perform at least part of the process; and
(c) causing the external processing apparatus to perform at least part of the process in such a manner to control a function of the information processing apparatus from the outside, in the event of determining, based on the information held at step (a), that a request received from the external processing apparatus is authenticated as corresponding to the request sent at step (b).

12. The service providing method according to claim 11, wherein:
step (b) comprises the step of sending the request to perform at least part of the process to the external processing apparatus using the function of the information processing apparatus.

13. The service providing method according to claim 11, wherein:
step (b) comprises the step of sending the request to perform at least part of the process to a control unit of the external processing apparatus that controls the function from the outside with the use of step (c).

14. The service providing method according to claim 11, wherein:
step (a) comprises the step of holding identification information of the external processing apparatus as the information used for authenticating the external processing apparatus being requested to perform at least part of the process; and
step (c) comprises the step of comparing identification information included in the request received from the external processing apparatus with the identification information held at step (a) to determine whether the request received from the external processing apparatus can be authenticated as corresponding to the request sent at step (b).

15. The service providing method according to claim 11, wherein:
step (a) comprises the step of holding a key generated from identification information of the external processing apparatus as the information used for authenticating the external processing apparatus being requested to perform at least part of the process; and
step (c) comprises the step of comparing a key included in the request received from the external processing apparatus with the key held at step (a) to determine whether the request received from the external processing apparatus can be authenticated as corresponding to the request sent at step (b).

16. The service providing method according to claim 15, wherein:
the key held at step (a) is generated by an authentication server connected to the information processing apparatus via the communication network.

17. The service providing method according to claim 15, wherein:
the key held at step (a) is generated by the information processing apparatus.

18. The service providing method according to claim 15, wherein:
the key held at step (a) is generated by the external processing apparatus.

19. The service providing method according to claim 15, wherein:
the key held at step (a) comprises at least one of a host name of the external processing apparatus, a location of the external processing apparatus in the communication network, a time at which the request is sent to the external processing apparatus at step (b), and a random character string.

20. A service providing program product comprising instructions for causing a computer of an information processing apparatus connected to an external processing apparatus via a predetermined communication network to execute a procedure, the information processing apparatus being configured to cause the external processing apparatus to perform at least part of a process of a predetermined service on behalf of the information processing apparatus, the procedure comprising the steps of:
(a) holding information used for authenticating the external processing apparatus being requested to perform at least part of the process;
(b) sending a request to the external processing apparatus to perform at least part of the process; and
(c) causing the external processing apparatus to perform at least part of the process in such a manner to control a function of the information processing apparatus from the outside, in the event of determining, based on the information held at step (a), that a request received from the external processing apparatus is authenticated as corresponding to the request sent at step (b).
